(19) United States
(12) Patent Application Publication
(10) Pub. No.: US 2017/0046380 A1
(43) Pub. Date: Feb. 16, 2017

(54) CONTENT MANAGING APPARATUS, CONTENT MANAGING METHOD AND NON-TRANSITORY COMPUTER-READABLE STORAGE MEDIUM STORING A PROGRAM

(71) Applicant: CANON KABUSHIKI KAISHA, Tokyo (JP)

(72) Inventor: Ikufumi Moriya, Funabashi-shi (JP)

(21) Appl. No.: 15/227,128

(22) Filed: Aug. 3, 2016

(30) Foreign Application Priority Data
Aug. 12, 2015 (JP) 2015-159535

(51) Int. Cl. G06F 17/30

(52) U.S. Cl. CPC G06F 17/30395; G06F 17/30554; G06F 17/3028

(57) ABSTRACT

A content managing apparatus, which can efficiently retrieve a content desired by a user, retrieves a content, by using a retrieval condition based on a first piece of attribute information associated with the content; displays the retrieval condition and the retrieved content on a screen; acquires a second piece of the attribute information different from the first piece of the attribute information used for the retrieval condition, associated with the content selected by a user from the displayed contents; and generates a new retrieval condition by adding the second piece of the attribute information to the retrieval condition.

### BACKGROUND OF THE INVENTION

Field of the Invention

The present invention relates to a content managing apparatus which retrieves a content, and a program to be used in the content managing apparatus.

Description of the Related Art

Recently, a content managing apparatus which registers and manages contents such as images and the like has been widespread. A content owner (or possessor) can register own content by transmitting it to the content managing apparatus, and then create a new content such as a photo book, a document or the like by using the registered content in the content managing apparatus. On another front, a reader (or browsing person) who is a user can acquire a desired content by retrieving contents in the content managing apparatus to narrow down the desired content therefrom, and then repeating the retrieval while confirming retrieval results.

As for such content retrieval, the content managing apparatus which generates, when performing the retrieval, a new retrieval condition based on the designated retrieval condition and user's retrieval trend (movement) and thus performs the efficient retrieval has been proposed (Japanese Patent Application Laid-Open No. 2010-257001). The relevant content managing apparatus compares the retrieval history stored and accumulated in the apparatus itself and the designated retrieval condition with each other, and, when the information of the retrieval condition exists in the retrieval history, includes the subordinate concept of the keyword of the retrieval condition in the new retrieval condition because the similar retrieval was performed. On the other hand, the relevant content managing apparatus comparers the retrieval history stored and accumulated in the apparatus itself and the designated retrieval condition with each other, and, when the information of the retrieval condition does not exist in the retrieval history, includes the superordinate concept of the keyword of the retrieval condition in the new retrieval condition because the retrieval is being performed within a wider range. Thus, since the user can acquire the new retrieval condition when the content managing apparatus performs the retrieval, he/she can acquire the retrieval result more efficiently.

However, there is a case where the user does not necessarily expect the retrieval based on the retrieval condition to which the superordinate or subordinate concept of the retrieval keyword same as or similar to the past retrieval trend (movement) has been added. For this reason, the expected retrieval condition is not necessarily acquired for the user by the content managing apparatus in Japanese Patent Application Laid-Open No. 2010-257001. Thus, there is a case where the efficient retrieval cannot be achieved.

An object of the present invention is to provide the content managing apparatus by which the user can efficiently retrieve the content that the user desires.

### SUMMARY OF THE INVENTION

A content managing apparatus according to the present invention is characterized by comprising: a processor; and a memory storing a program which, when executed by the processor, causes the content managing apparatus to: retrieve a content, by using a retrieval condition based on a first piece of attribute information associated with the content; display the retrieval condition and the retrieved content on a screen; acquire a second piece of the attribute information different from the first piece of the attribute information used for the retrieval condition, associated with the content selected by a user from the displayed contents; and generate a new retrieval condition by adding the second piece of the attribute information to the retrieval condition.

According to the present invention, since the retrieval condition to which the attribute information of the content has been added is generated, it is possible to perform the retrieval based on the attribute information of the content. Therefore, it is possible to efficiently retrieve the content that the user desires and to acquire the desired retrieval result.

Further features of the present invention will become apparent from the following description of exemplary embodiments with reference to the attached drawings.

### BRIEF DESCRIPTION OF THE DRAWINGS

FIG. 1 is a block diagram for illustrating the constitution of a content managing apparatus according to the first embodiment of the present invention.

FIGS. 2A, 2B, 2C and 2D are diagrams for describing an example of the user interface of the content managing apparatus according to the first embodiment.

FIGS. 3A, 3B and 3C are diagrams for describing examples of tables on which content information is stored, in the content managing apparatus according to the first embodiment.

FIGS. 4A and 4B are diagrams for describing examples of tables on which retrieval conditions are stored, in the content managing apparatus according to the first embodiment.

FIG. 5 is a flow chart for describing a process of retrieving a content, in the content managing apparatus according to the first embodiment.

FIG. 6 is a flow chart for describing a process of generating a retrieval condition for retrieving a content, in the content managing apparatus according to the first embodiment.

FIGS. 7A, 7B, 7C, 7D and 7E are diagrams for describing an example of the user interface of the content managing apparatus according to the first embodiment.

FIG. 8 is a flow chart for describing a process of storing the retrieval condition for retrieving the content, in the content managing apparatus according to the first embodiment.

FIG. 9 is a flow chart for describing a process of displaying the stored retrieval condition, in the content managing apparatus according to the first embodiment.

FIG. 10 is a flow chart for describing a process of deleting the retrieval condition, in the content managing apparatus according to the first embodiment.

FIGS. 11A, 11B, 11C, 11D and 11E are diagrams for describing an example of the user interface of the content managing apparatus according to the first embodiment.

FIG. 12 is a flow chart for describing a process of editing the retrieval condition, in the content managing apparatus according to the first embodiment.

FIG. 13 is a flow chart for describing a process of adding an alternative retrieval condition, in the content managing apparatus according to the second embodiment of the present invention.

### DESCRIPTION OF THE EMBODIMENTS

Hereinafter, preferred embodiments of the present invention will exemplarily be described in detail in accordance with the accompanying drawings. However, the constitutional elements described in the preferred embodiments are persistently exemplified elements, and the scope of the present invention is not limited only to these elements.

### First Embodiment

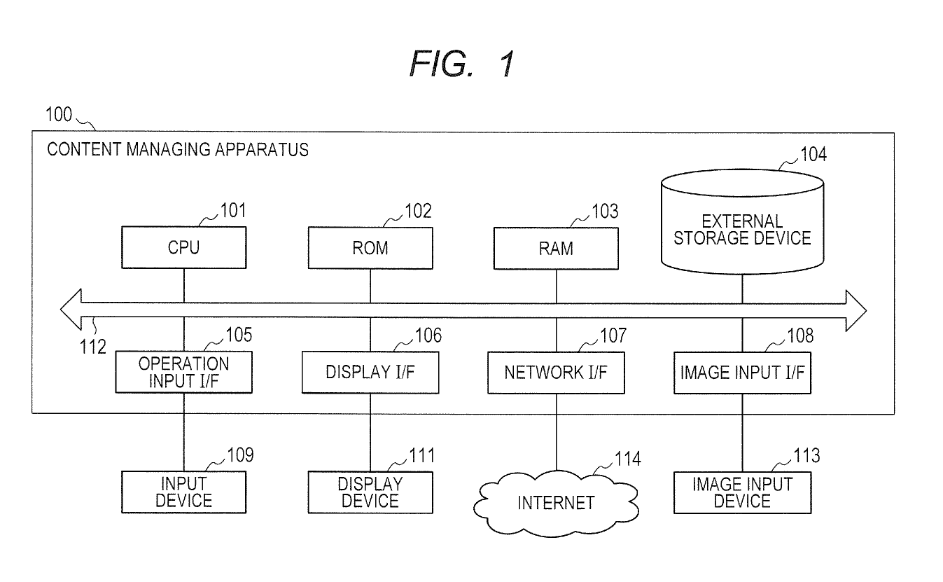

FIG. 1 is a block diagram for illustrating the constitution of a computer apparatus which serves as a content managing apparatus 100 according to the first embodiment of the present invention. Incidentally, the content managing apparatus 100 may be achieved by the single computer apparatus, or may be achieved by distributing respective functions to a plurality of computer devices according to necessity. When the content managing apparatus is constituted by the plurality of computer devices, the respective computer devices are communicably connected with others via a LAN (local area network) or the like.

The content managing apparatus 100 comprises a CPU (central processing unit) 101, a ROM (read only memory) 102, a RAM (random access memory) 103, an external storage device 104, an operation input I/F (interface) 105, a display I/F 106, a network I/F 107 and an image input I/F 108. Here, the CPU 101, the ROM 102, the RAM 103, the external storage device 104, the operation input I/F 105, the display I/F 106, the network I/F 107 and the image input I/F 108 are electrically connected to a system bus 112 respectively.

The CPU 101, serving as a retrieving unit, an acquiring unit, a generating unit, a sorting unit, a deleting unit and an editing unit, controls the whole of the content managing apparatus 100. The CPU 101 receives signals input from an input device 109 such as a pointing device, a keyboard and the like, reads out and executes the programs stored in the RAM 103 in response to the input signals, and creates and retrieves photo books according to the executed programs. Here, it should be noted that the photo book is equivalent to a certain content which is created by gathering image contents. The CPU 101 performs display control by controlling the display I/F 106 to display the created photo book on a display device 111 serving as a displaying unit. Moreover, the CPU 101 controls the network I/F 107 to perform communication control with an external device (not illustrated) via the Internet 114. Moreover, the CPU 101 controls the image input I/F 108 to acquire an image from an image input device 113.

The ROM 102 stores therein various control programs and parameters, and the RAM 103 temporarily stores therein programs and data supplied from the external storage device 104, the Internet 114 and the like. Also, the RAM 103 is used as a working area for the CPU 101, and a working memory such as a program load area or the like. The external storage device 104, serving as a storing unit, includes a hard disk and a memory card integrally provided with the content managing apparatus 100, or includes an optical disk, a magnetic card, an optical card, an IC (integrated circuit) card and the like attachable/detachable to/from the content managing apparatus 100. Attribute information representing the feature of the photo book is given to the relevant photo book in which a user has arranged images, and the photo book having the attribute information is registered in the external storage device 104. In addition, a retrieval condition for the photo book has been registered in the external storage device 104.

The operation input I/F 105 is the interface with the input device 109 such as the pointing device, the keyboard and the like for inputting various data in response to user's operations. The display I/F 106 is the interface with the display device 111 such as a display or the like for displaying the data of the content managing apparatus 100 and the data supplied under the control of the CPU 101. The network I/F 107 is the network interface which is used to connect a network line such as the Internet 114 and the like, and performs communication with a communicable external device.

The image input I/F 108 is the interface with the image input device 113. The CPU 101 acquires image data from the image input device 113 via the image input I/F 108, and stores the acquired image data in the external storage device 104. For example, a digital camera, a video camera, a scanner or the like is used as the image input device 113. Incidentally, the processes to be described later are achieved on the premise that the CPU 101 of the content managing apparatus 100 reads and starts the programs supplied from the external storage device 104, the Internet 114 and the like and then controls various devices according to the relevant programs.

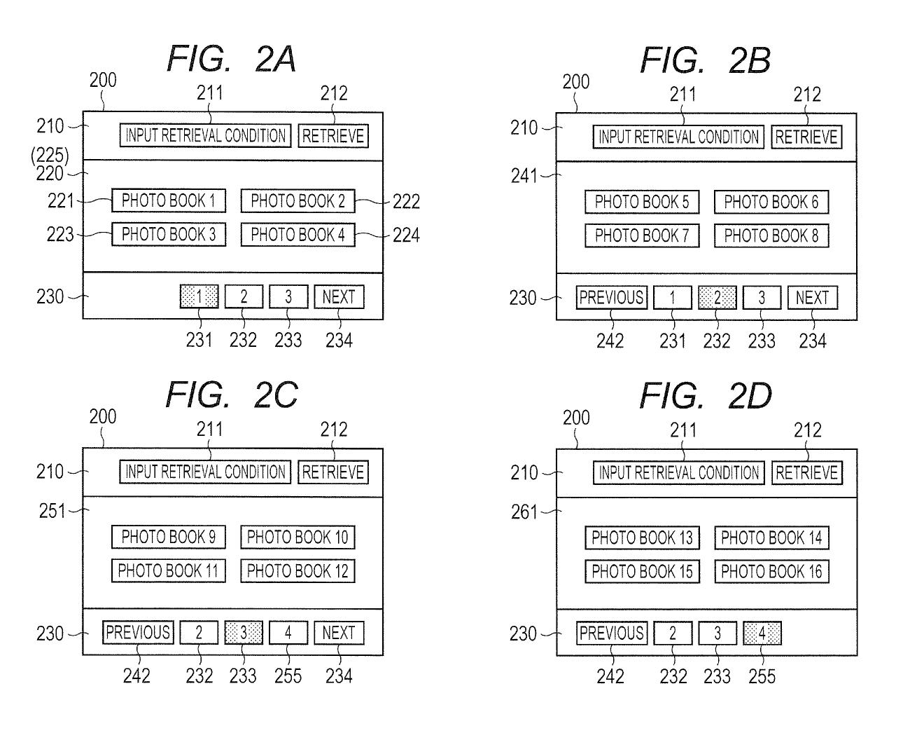

Subsequently, content retrieval in the content managing apparatus 100 according to the present embodiment will be described. FIGS. 2A to 2D are diagrams for describing an example of the user interface of the content managing apparatus 100 according to the first embodiment. On a screen 200 illustrated in each of FIGS. 2A to 2D, a retrieval result corresponding to the retrieval condition input to an input area 211 is displayed. Here, the screen 200 is the screen by which the user retrieves the content (hereinafter, called the photo book) registered in the content managing apparatus 100. The screen 200 consists of areas 210, 220 and 230.

The input area 211 for the retrieval condition and a retrieval button 212 are arranged in the area 210. The input area 211 for the retrieval condition is used when the CPU 101 retrieves the photo book, and the retrieval condition is displayed in this area. The retrieval button 212 is used to perform the retrieval of the photo book in the retrieval condition set and displayed in the input area 211. When the retrieval button 212 is depressed, the retrieval of the photo book is performed in the retrieval condition set and displayed in the input area 211. In the area 220, photo books 221 to 224 which are the retrieval result satisfying the retrieval condition are arranged and displayed on a page 225. The page 225 to be displayed in the area 220 is switched to a predetermined page by depression of each of buttons 231 to 234.

In the area 230, the buttons 231 to 234 for switching the page on which the retrieval result of the photo book is displayed are arranged. If the entire retrieval result cannot be displayed only on the page 225 of the area 220, it is possible by depressing each of the buttons 231 to 234 to display the photo book(s), which cannot be displayed on the page 225, on another page. Namely, each of the buttons 231 to 233 is the button for switching the page displayed in the area 220 to each of the pages respectively assigned to the buttons 231 to 233. The button 234 is the button for displaying the page following (next to) the page displayed in the area 220, and a button 242 is the button for displaying the page previous to the page displayed in the area 220. The number of the buttons to be displayed in the area 230 changes or varies according to the number of the retrieved photo books.

Then, transition of the screen 200 displaying the retrieval result will be described with reference to FIGS. 2A to 2D. When the depression of the button 231 is detected, the CPU 101 displays the page 225 which is the first page in the entire retrieval result. When the depression of the button 232 is detected, the CPU 101 switches the display to a page 241 which is the second page in the entire retrieval result. When the depression of the button 233 is detected, the CPU switches the display to a page 251 which is the third page in the entire retrieval result. When the depression of the button 234 is detected, the CPU 101 displays the page following the page displayed at that point. For example, when a page feeding (turnover) request by the depression of the button 234 is detected, the CPU 101 switches the page 225 in the area 220 to the page 241 and displays the photo books 5 to 8. In this case, the buttons 242 and 231 to 234 are displayed in the area 230.

In FIG. 2B, when the depression of the button 242 is detected, the CPU 101 switches the display to the page prior to the page displayed at that point, that is, the display of the screen 200 illustrated in FIG. 2A. When the depressions of the respective buttons 231, 232 and 233 are detected, the CPU 101 switches the display to the page 225 being the first page in the entire retrieval result, to the page 241 being the second page therein, and to the page 251 being the third page therein, respectively. When the depression of the button 234 is detected, the CPU 101 switches the page 241 to the page 251 so as to display the page following the page displayed at that point. As illustrated in FIG. 2C, the buttons 232 to 234, 242 and 255 are arranged in the area 230. When the depression of the button 242 is detected, the CPU 101 switches the page 251 to the page 241. When the depression of the button 234 is detected, the CPU 101 switches the page 251 to a page 261 as illustrated in FIG. 2D. In FIG. 2D, the buttons 232, 233, 242 and 255 are displayed in the area 230. In FIG. 2D, the button 234 is not arranged on the immediate right side of the button 255, because the display reaches the final page in the entire retrieval result. Incidentally, the respective screen (display) transitions at the time when the buttons 232, 233 and 255 are depressed are the same as those described above.

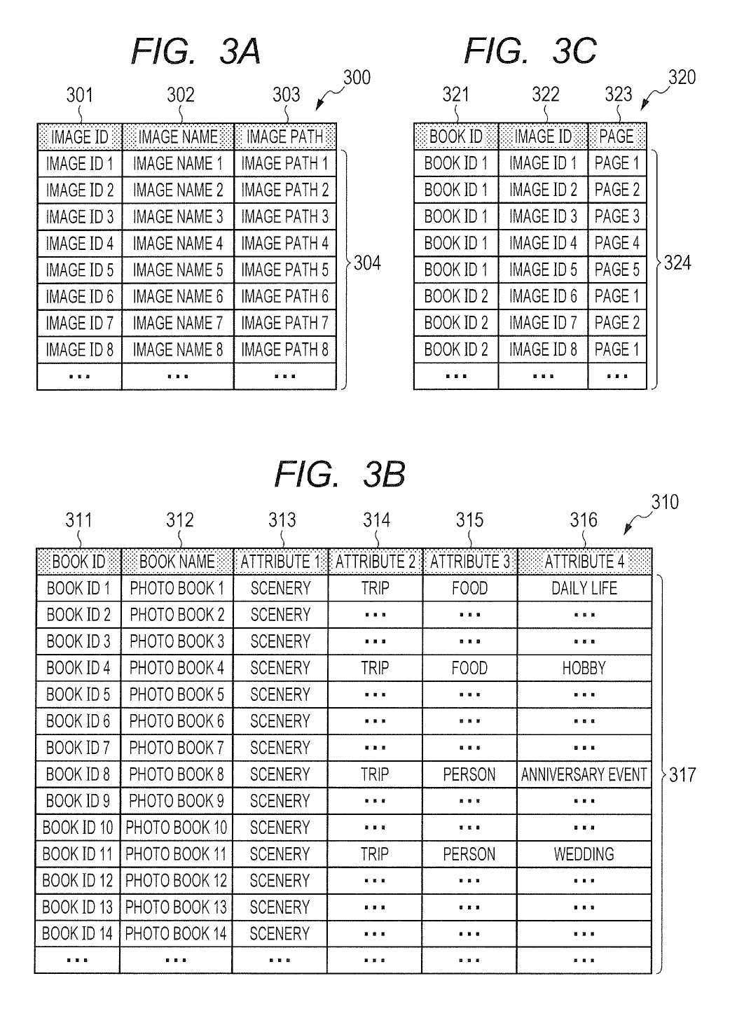

Next, an example that the images constituting the photo books and the information for managing the photo books are stored in the content managing apparatus 100 will be described hereinafter. FIGS. 3A to 3C are diagrams for exemplarily describing tables on which the content information according to the present embodiment is stored. Here, the table illustrated in each of FIGS. 3A to 3C has been stored in the external storage device 104. An image table 300 illustrated in FIG. 3A is the table for storing the information of the images to be managed by the content managing apparatus 100. The image table 300 consists of fields 301 to 303. An image ID (identification), which is stored in the field 301, is the attribute corresponding to an identifier for uniquely identifying an image. An image name, which is stored in the field 302, is the attribute indicating a name of the image. An image path, which is stored in the field 303, is the attribute corresponding to a path indicating whereabouts of the image in the content managing apparatus 100. A record 304 is the records in the image table 300.

A book table 310 illustrated in FIG. 3B is the table for storing the information of the photo books to be managed by the content managing apparatus 100. The book table 310 consists of fields 311 to 316. A book ID, which is stored in the field 311, is the attribute corresponding to an identifier for uniquely identifying a photo book. A book name, which is stored in the field 312, is the attribute corresponding to a name of the photo book. Attributes 1 to 4 are stored in the fields 313 to 316 respectively. The attributes 1 to 4 are the attributes corresponding to features of the photo book. Each of the attributes 1 to 4 is the attribute information corresponding to the photo book, used when the CPU 101 retrieves the photo book, and displayed in the input area 211 on the screen 200 in the form of list. For example, if “scenery” is designated as the retrieval condition in the input area 211 on the screen 200, the CPU 101 compares the retrieval condition “scenery” with the attribute information of each of the attributes 1 to 4, and acquires the record in which the retrieval condition coincides with the attribute information. For example, the attributes 1 to 4 may be set by a user or based on the information acquired from the image. Incidentally, a record 317 illustrated in FIG. 3B is the records of the book table 310. The number of the attributes in the book table 310 is not limited to that illustrated in this drawing.

A book-arranged-image table 320 illustrated in FIG. 3C is the table for storing the information of the images arranged on the photo books to be managed by the content managing apparatus 100. The book-arranged-image table 320 consists of fields 321 to 323. A book ID, which is stored in the field 321, is the attribute corresponding to an identifier for uniquely identifying a photo book. An image ID, which is stored in the field 322, is the attribute corresponding to an identifier for uniquely identifying an image. A page, which is stored in the field 323, is the attribute corresponding to a page number of the photo book on which the image/images is/are arranged. For example, when a photo book creation request is detected, the CPU 101 acquires the information and the name of the image arranged on the page of the photo book, and registers the image name and the image path thereof as the record of the image table 300. Then, the CPU 101 registers the record of the book table 310 as the information of the photo book which bunches (bundles) the pages on which the images are arranged respectively. Finally, the CPU registers the record of the book-arranged-image table 320 and associates the photo book and the image with each other, based on the values of the image ID of the image registered to the image table 300 and the book ID of the photo book registered to the book table 310. A record 324 illustrated in FIG. 3C is the records of the book-arranged-image table 320.

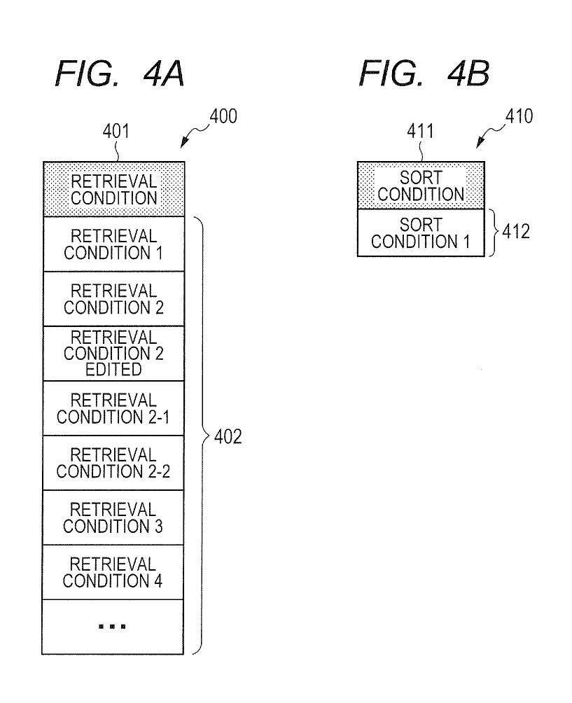

Subsequently, examples of tables on which information for managing the retrieval conditions is stored in the content managing apparatus 100 will be described with reference to FIGS. 4A and 4B. FIGS. 4A and 4B are the diagrams for exemplarily describing the tables on which the information for managing the retrieval conditions is stored. For example, the table illustrated in each of FIGS. 4A and 4B has previously been stored in the external storage device 104. A retrieval condition table 400 illustrated in FIG. 4A is the table for storing the information of the retrieval condition to be managed by the content managing apparatus 100. The retrieval condition table 400 consists of a field 401. The retrieval condition, which is stored in the field 401, is the attribute corresponding to the retrieval condition which is used by the content managing apparatus 100 to retrieve the photo book as the content. A field 402 is the records of the retrieval condition table 400.

A sort condition table 410 illustrated in FIG. 4B is the table for storing a sort condition of the retrieval condition to be displayed by the content managing apparatus 100. The sort condition table 410 consists of a field 411. The sort condition is the attribute corresponding to the condition which is used by the content managing apparatus 100 to sort and display the retrieval condition when retrieving the photo book. As the sort condition, for example, a condition indicating retrieval condition display priority such as a condition by which a larger number of retrievals can be acquired is registered. A record 412 is the record of the sort condition table 410.

Next, a process to be performed when the CPU 101 of the content managing apparatus 100 retrieves the content will be described with reference to FIG. 5. FIG. 5 is the flow chart for describing the process of retrieving the content, according to the present embodiment. Incidentally, it should be noted that the processes in the flow charts illustrated in FIG. 5 and the following drawings are performed on the premise that the CPU 101 executes the programs stored in the ROM 102.

In S501, the CPU 101 decides whether or not the retrieval request of content by the depression of the retrieval button 212 is detected. When the retrieval request is detected (S501: YES), the CPU 101 acquires the retrieval request (S502). On the other hand, when the retrieval request is not detected (S501: NO), the CPU 101 waits until the retrieval request is detected. In S502, the CPU 101 acquires the retrieval condition set in the input area 211 on the screen 200. In S503, the CPU 101 retrieves the photo book as the content by using the acquired retrieval condition. More specifically, the CPU retrieves the record in the field 313 of the book table 310 by using the acquired retrieval condition. In S504, the CPU 101 acquires the retrieval result. More specifically, the CPU retrieves the attribute which coincides with the retrieval condition from the book table 310, and acquires the coincident record. In S505, the CPU 101 arranges the acquired record on the page, and displays the relevant page in the area 220 on the screen 200. For example, if “scenery” is set to the input area 211, the CPU 101 acquires “scenery” as the retrieval condition, and retrieves the photo book for which “scenery” has been set to the attribute information in the field 313 of the book table 310. Then, the CPU 101 acquires the record which coincides with the retrieval condition “scenery”, and displays the book names in the acquired record on the screen 200 as illustrated in FIGS. 2A to 2D. Incidentally, in FIGS. 2A to 2D, the photo books corresponding to the retrieval condition are the photo books 1 to 16.

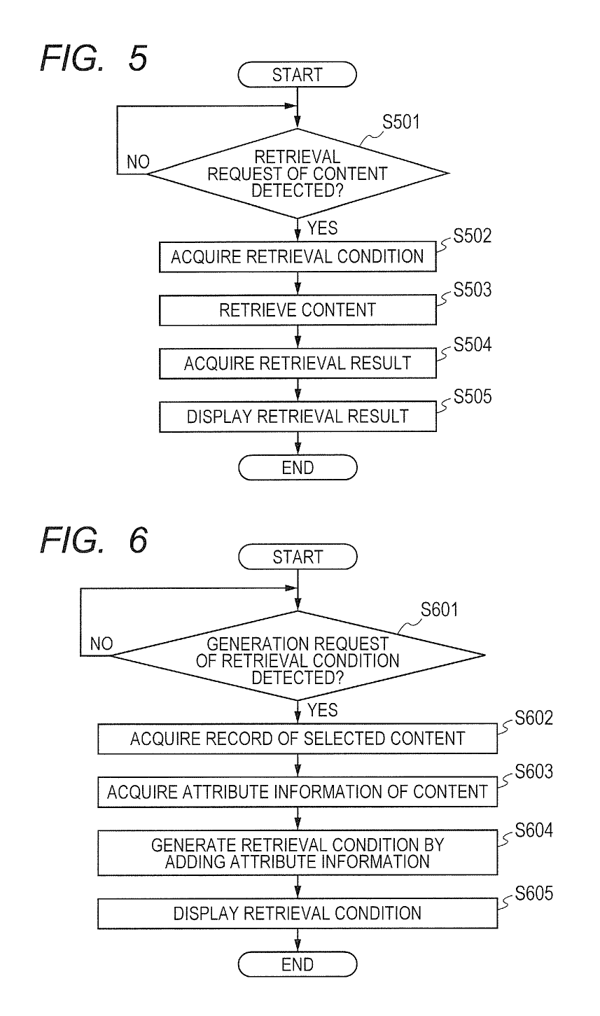

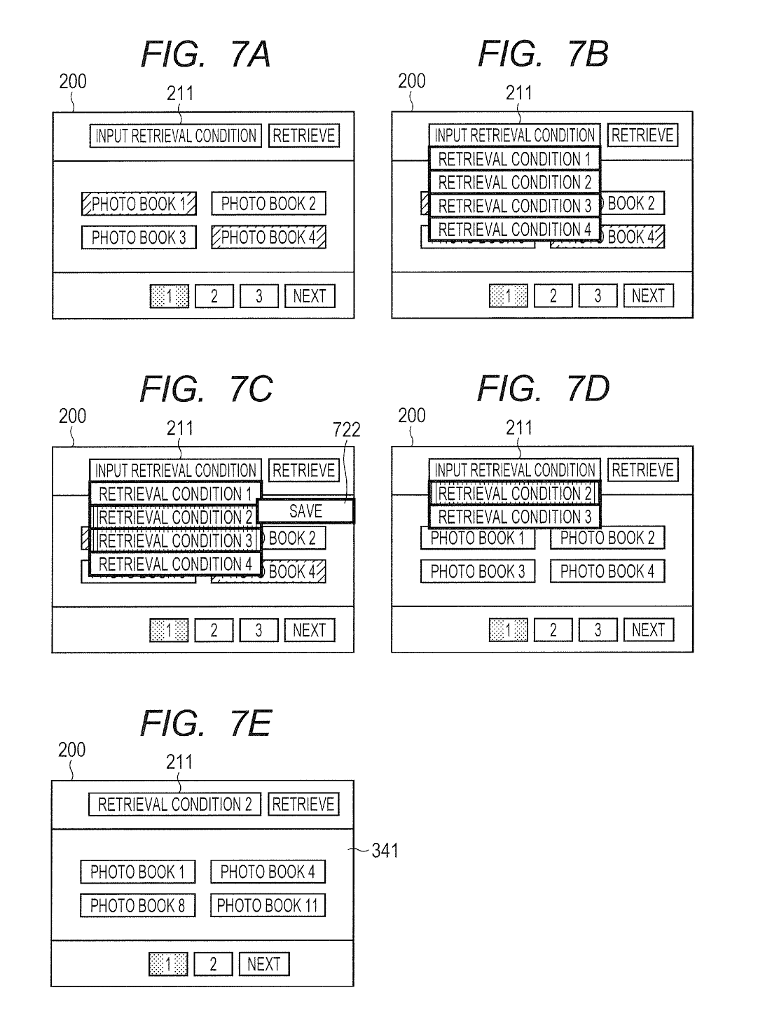

Next, a process to be performed when the retrieval condition is generated will be described with reference to FIG. 6 and FIGS. 7A to 7E. FIG. 6 is the flow chart for describing the process of generating the retrieval condition for content retrieval, in the content managing apparatus 100 according to the present embodiment. FIGS. 7A to 7E are the diagrams for describing an example of the user interface of the content managing apparatus 100 according to the present embodiment. Here, it is assumed that the retrieval process indicated by the flow chart of FIG. 5 was performed before the process described in FIG. 6 is performed.

In S601, the CPU 101 decides whether or not a generation request of the retrieval condition is detected. As illustrated in FIG. 7A, the CPU 101 performs the process in S601 when the input area 211 of the retrieval condition is depressed in the state that the photo books 1 and 4 are selected from the photo books of the retrieval result displayed on the screen 200. When the generation request is detected (S601: YES), the CPU 101 acquires the selected content (S602). On the other hand, when the generation request is not detected (S601: NO), the CPU 101 waits until the generation request is detected. In S602, the CPU 101 acquires the record of the selected content. More specifically, the CPU 101 acquires the records corresponding to the photo books 1 and 4 selected in FIG. 7A, from the book table 310.

In S603, the CPU 101 acquires the attribute information from the record of the contents acquired in S602. More specifically, the CPU 101 acquires the attribute information of the photo books 1 and 4 selected from among the attributes 1 to 4, in the record acquired from the book table 310. The CPU 101 acquires the attribute information “scenery”, “trip”, “food” and “daily life” of the photo book 1 from the book table 310, and acquires the attribute information “scenery”, “trip”, “food” and “hobby” of the photo book 4 from the book table 310.

In S604, the CPU 101 generates a new retrieval condition by adding the acquired attribute information to the original retrieval condition. More specifically, the CPU 101 generates a retrieval condition “scenery and trip” by adding the attribute information “trip” of the attribute to “scenery” being the original retrieval condition of the retrieval condition newly generated in S604. Incidentally, it may possible to, in addition to the attribute information of the photo book, include, in the retrieval condition, photo book meta information such as the book name, image meta information such as the image name of the image associated with the page of the photo book page, and the like.

In S605, the CPU 101 displays the retrieval condition generated in S604 on the screen 200. If there are the plurality of retrieval conditions generated, the CPU 101 sorts the retrieval conditions according to the sort condition 1 in the record 412 of the sort condition table 410 illustrated in FIG. 4B, and then displays the generated retrieval conditions on the screen 200. In FIG. 7B, the retrieval conditions 1 to 4 are displayed in the sorted order according to the sort condition 1. For example, it is assumed that the sort condition 1 corresponds to the number of retrievals. In this case, in the retrieval conditions 1 to 4 displayed on the screen 200, the retrieval condition corresponding to the maximum number of retrievals is the retrieval condition 1, and the retrieval condition corresponding to the minimum number of retrievals is the retrieval condition 4.

As illustrated in FIG. 7B, the retrieval conditions 1 to 4 generated in S604 are displayed on the screen 200. For example, when the CPU 101 performs the process in S602 in the state that the photo books 1 and 4 have been selected as in FIG. 7A, the CPU acquires the records of the book table 310 corresponding to the photo books 1 and 4. Then, by performing the process in S603, it is possible for the CPU 101 to generate the new retrieval condition by acquiring the attribute information “trip” of the attribute 2 in the field 314, the attribute information “food” of the attribute 3 in the field 315, and the like of the record.

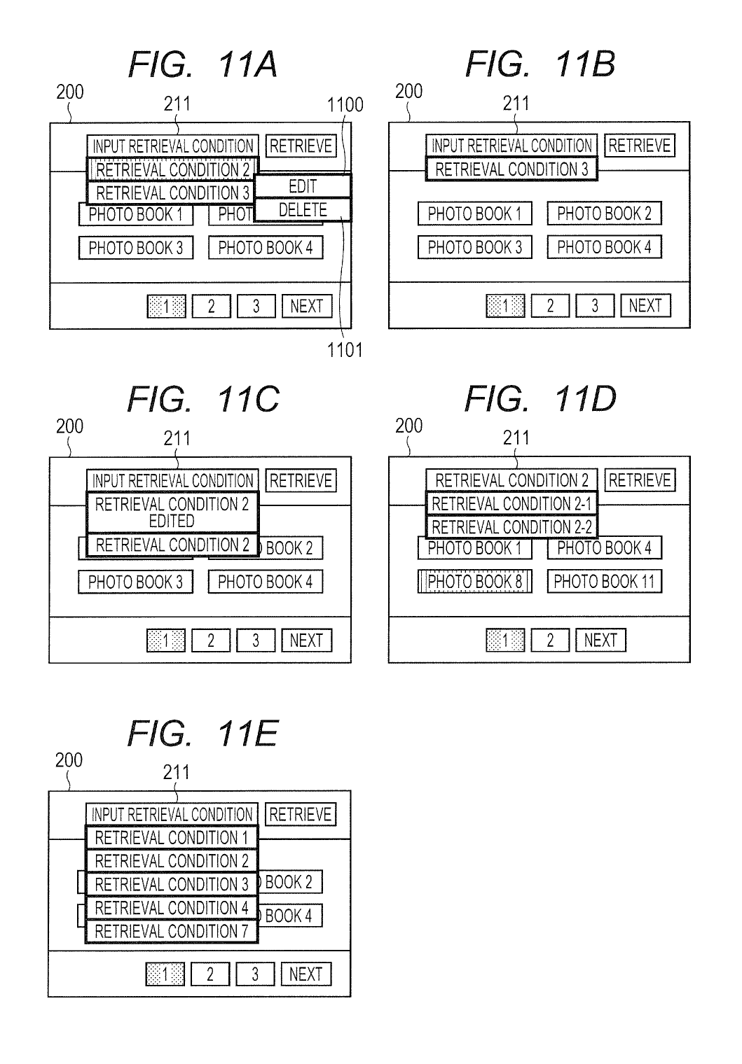

It is possible to further narrow down the retrieval condition by using the process of generating the retrieval condition in FIG. 6. For example, the CPU 101 performs the processes in S601 to S605 in the state that the retrieval condition 2 has been set to the input area 211 of FIG. 7E and the photo book 8 has been further selected as in FIG. 11D. Thus, it is possible for the CPU 101 to generate and display the retrieval condition “scenery and trip and person and anniversary event” in which the attribute information of the photo book 8 has been further added to the original retrieval condition “scenery and trip”. As just described, it is possible for the user to further narrow down the retrieval condition by sequentially selecting the photo book(s) from the screen 200.

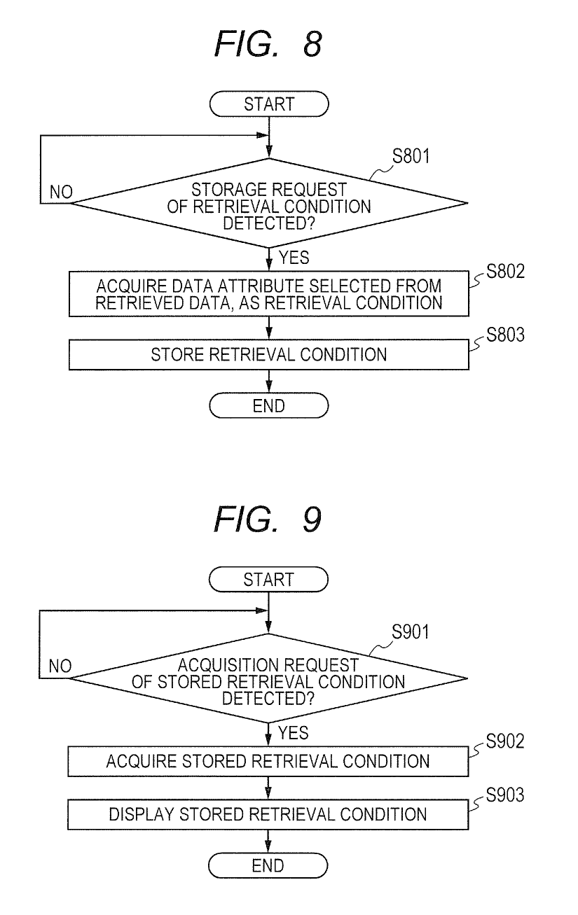

Next, a process to be performed when the CPU stores the retrieval condition will be described with reference to FIGS. 7A to 7E and FIG. 8. Here, FIG. 8 is the flow chart for describing the process of storing the retrieval condition for retrieving the content, in the content managing apparatus 100 according to the present embodiment. Incidentally, it is assumed that the retrieval conditions 1 to 4 descried below are the retrieval conditions generated by the process indicated by the flow chart of FIG. 6.

In S801, the CPU 101 decides whether or not a storage request of the retrieval condition is detected. More specifically, as illustrated in FIG. 7C, when the right click is detected in the state that the retrieval conditions 2 and 3 are being selected from the retrieval conditions 1 to 4 displayed on the screen 200, the CPU 101 displays a button 722 for saving or storing the retrieval condition. Then, when the depression of the button 722 is detected, the CPU 101 performs the process in S801. When the storage request is detected (S801: YES), the CPU 101 acquires the selected retrieval condition (S802). Namely, the CPU acquires the attribute of the data selected from the retrieved data, as the retrieval condition (S802). On the other hand, when the storage request is not detected (S801: NO), the CPU 101 waits until the storage request is detected.

In S802, the CPU 101 acquires the retrieval condition for which the storage request has been detected. In FIG. 7C, the CPU 101 acquires the retrieval conditions of the retrieval conditions 2 and 3. In S803, the CPU 101 stores the acquired retrieval condition to the retrieval condition table 400. In FIG. 7C, the CPU 101 stores the retrieval conditions 2 and 3 by registering them as the record of the retrieval condition table 400.

Next, a process to be performed when the CPU displays the stored retrieval condition will be described with reference to FIGS. 7A to 7E and FIG. 9. FIG. 9 is the flow chart for describing the process of displaying the stored retrieval condition, in the content managing apparatus 100 according to the present embodiment. In S901, the CPU 101 decides whether or not an acquisition request of the stored retrieval condition is detected. More specifically, as illustrated in FIG. 7D, when the depression of the input area 211 on the screen 200 is detected, the CPU 101 performs the process in S901. When the acquisition request of the stored retrieval condition is detected (S901: YES), the CPU 101 acquires the stored retrieval condition (S902). On the other hand, when the acquisition request of the stored retrieval condition is not detected (S901: NO), the CPU 101 waits until the acquisition request is detected.

In S902, the CPU 101 acquires the stored retrieval condition from the retrieval condition table 400. In FIG. 7C, the stored retrieval condition corresponds to the retrieval conditions 2 and 3. In S903, the CPU 101 displays the stored retrieval condition acquired in S902 on the screen 200. For example, as illustrated in FIG. 7C, the CPU 101 acquires the record of the retrieval condition table 400 by performing the process in S902. When the acquired record corresponds to the retrieval conditions 2 and 3, the CPU 101 displays the retrieval conditions 2 and 3 by performing the process in S903, as illustrated in FIG. 7D. Incidentally, in S902, when the retrieval condition other than the retrieval conditions 2 and 3 has already been registered on the retrieval condition table 400, for example, it may be possible for the CPU 101 to acquire only the retrieval condition stored immediately before the acquisition request of the stored retrieval condition is detected.

When the stored retrieval condition is displayed on the screen 200 and the retrieval condition 2 is selected as illustrated in FIG. 7D, the CPU 101 sets the selected retrieval condition 2 to the input area 211 as illustrated in FIG. 7E. When the retrieval button 212 is depressed, the CPU 101 retrieves the photo book which coincides with the retrieval condition 2 by performing the processes in S501 to S505. Thus, it is possible to display the more narrowed photo books in a page 341.

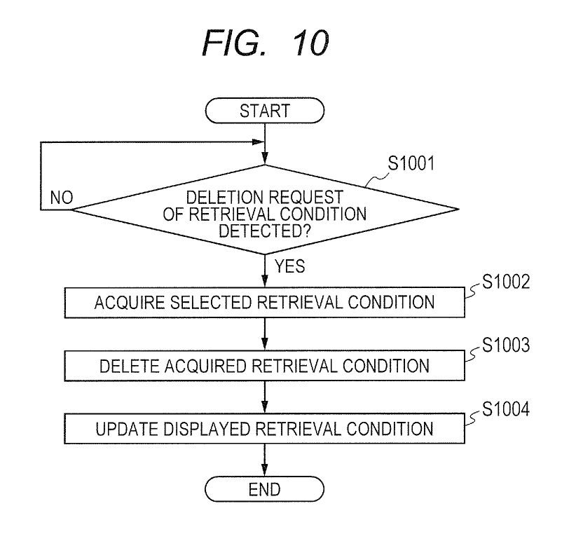

Subsequently, a process to be performed when the CPU deletes the retrieval condition will be described with reference to FIG. 10 and FIGS. 11A to 11E. FIG. 10 is the flow chart for describing the process of deleting the retrieval condition, in the content managing apparatus 100 according to the present embodiment. Further, FIGS. 11A to 11E are the diagrams for exemplarily describing the user interface of the content managing apparatus according to the present embodiment.

In S1001, the CPU 101 decides whether or not a deletion request of the retrieval condition is detected. More specifically, as illustrated in FIG. 11A, when the right click is detected in the state that the retrieval condition 2 is being selected, the CPU 101 displays an edit button 1101 and a delete button 1101. Then, when the depression of the delete button 1101 is detected, the CPU 101 performs the process in S1001. When the deletion request is detected (S1001: YES), the CPU 101 acquires the selected retrieval condition. On the other hand, when the deletion request is not detected (S1001: NO), the CPU 101 waits until the deletion request is detected. In S1003, the CPU 101 deletes the retrieval condition acquired in S1002, from the retrieval condition table 400. In S1004, the CPU 101 updates the display of the retrieval condition. Namely, as illustrated in FIG. 11B, the display of the input area 211 on the screen 200 is updated so as to display only the retrieval condition 3.

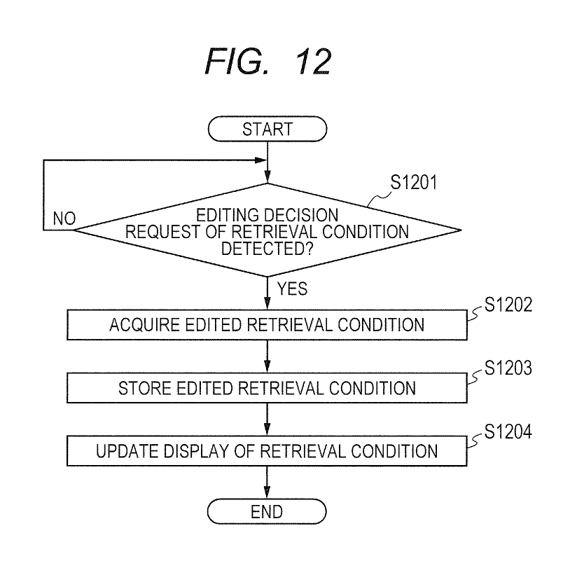

Next, a process to be performed when the CPU 101 edits the retrieval condition will be described with reference to FIGS. 11A to 11E and FIG. 12. FIG. 12 is the flow chart for describing the process of editing the retrieval condition, in the content managing apparatus 100 according to the present embodiment. Here, it is assumed that the editing of the retrieval condition is performed on the screen 200 before the process in this flow chart is performed. It may be possible to edit the retrieval condition on, for example, a screen dedicated for the retrieval condition editing, or to directly edit the selected retrieval condition 2 in the state displayed in FIG. 11A.

In S1201, the CPU 101 decides whether or not an editing decision request of the retrieval condition is detected. Here, editing decision corresponds to a state that editing of the retrieval condition has been decided or settled. When the editing decision of the retrieval condition is detected, the CPU 101 performs the process in S1201. When the editing decision request is detected (S1201: YES), the CPU 101 acquires the edited retrieval condition (S1202). On the other hand, when the editing decision request is not detected (S1201: NO), the CPU 101 waits until the editing decision request is detected.

In S1203, the CPU 101 stores the edited retrieval condition to the retrieval condition table 400. More specifically, the CPU 101 registers the edited retrieval condition 2 to the retrieval condition table 400. In S1204, the CPU 101 updates the display of the retrieval condition displayed on the screen 200. For example, as illustrated in FIG. 11C, when the depression of the edit button 1100 is detected in the state that “retrieval condition 2” has been edited to “retrieval condition 2 edited”, the CPU 101 updates the record of the retrieval condition table 400 corresponding to “retrieval condition 2” to “retrieval condition 2 edited”. Incidentally, although the photo book is used as the content in the present embodiment, the content is not limited to the photo book. It is needless to say that various retrievable objects such as an image, a document and the like can be used as the content.

By detecting the depressions of the edit button 1100 and the delete button 1101 respectively, it is possible for the CPU 101 to decide (settle) the edited result in the retrieval condition and delete the stored retrieval condition respectively. For example, when the depression of the edit button 1100 is detected in the state that the retrieval condition 2 has been edited, it is possible for the CPU 101 of the content managing apparatus to decide (settle) the editing to the retrieval condition 2 as illustrated in FIG. 11C.

As just described, according to the present invention, it is possible to efficiently retrieve the content that the user wishes, by retrieving the photo books, and generating the narrow-down retrieval condition based on the attribute of the photo book selected from the retrieved result.

### Second Embodiment

Subsequently, a second embodiment of the present invention will be described. The present embodiment is different from the first embodiment in that an alternative retrieval condition which serves as another retrieval condition by which the retrieval result same as that of a retrieval condition acquired by adding an attribute to an original retrieval condition can be derived is displayed together with the retrieval condition on the screen 200. Here, the constitutions same as those in the first embodiment are denoted respectively by the reference numerals and symbols same as those in the first embodiment, and the description thereof is omitted in the present embodiment.

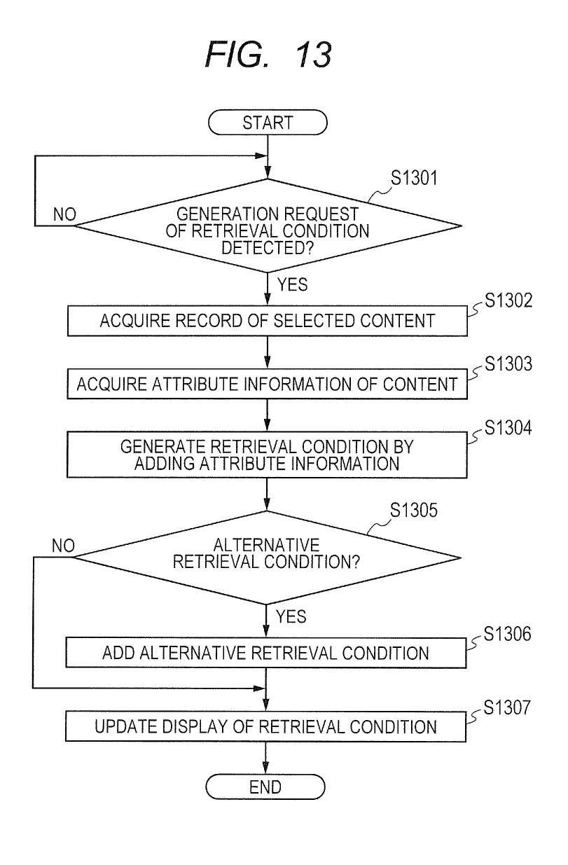

A process of displaying the alternative retrieval condition, by which the retrieval result same as that acquired by the original retrieval condition can be acquired, together with the retrieval condition will be described with reference to FIG. 13. FIG. 13 is the flow chart for describing the process of adding the alternative retrieval condition, in the content managing apparatus 100 according to the present embodiment. Here, since processes in S1301 to S1304 are the same as those in S601 to S604, the description thereof is omitted.

In S1305, the CPU 101 decides whether or not the alternative retrieval condition by which the same retrieval condition as that derived by the retrieval condition generated in S1304 can be derived exists on the retrieval condition table 400. When the alternative retrieval condition exists on the retrieval condition table 400 (S1305: YES), the CPU 101 adds the alternative retrieval condition as a new retrieval condition (S1306). In S1306, the CPU 101 adds, as the retrieval condition for display, the alternative retrieval condition to the retrieval condition generated in S1304. On the other hand, when the alternative retrieval condition does not exist on the retrieval condition table 400 (S1305: NO), the CPU 101 updates the display of the retrieval condition (S1307). In S1307, the CPU 101 sorts the generated retrieval condition and the alternative retrieval condition according to the sort condition of the sort condition table 410, and then displays the sorted retrieval conditions on the screen 200.

For example, in the record of the book table 310, the photo books 1, 4, 8 and 11 coincide with the retrieval condition “scenery and trip”. It is possible to add the retrieval condition “‘“scenery and trip and food” or “scenery and trip and person”’” for acquiring the above records, as the new retrieval condition serving as the alternative to “scenery and trip”. As illustrated in FIG. 11E, in addition to the generated retrieval conditions 1 to 4, the retrieval condition 7 which serves as the alternative retrieval condition by which the retrieval result same as that acquired by the retrieval conditions 1 to 4 can be derived is added to the retrieval condition and displayed on the screen 200.

As just described, in the present embodiment, when the alternative retrieval condition by which the retrieval result same as that derived by the generated retrieval condition can be derived exists on the retrieval condition table 400, the alternative retrieval condition is added to the generated retrieval condition, and these conditions are together displayed on the screen 200. Thus, it is possible to perform the more efficient retrieval because the selectable retrieval conditions increase.

As just described, although the present invention has been described in detail based on the above embodiments, the present invention is not limited to the above specific embodiments. Namely, the present invention includes various embodiments other than the above embodiments within the scope which does not departs from the concept of the present invention. Besides, the present invention may include an embodiment obtained by appropriately combining part(s) of the above embodiments with the above various embodiments.

Moreover, the present invention includes a case where software programs for achieving the functions of the above embodiments are supplied to a system or an apparatus having a computer capable of executing the programs directly from a recording medium or via wired/wireless communication and the supplied programs are actually executed in the system or the apparatus.

Therefore, also program codes themselves to be supplied and installed to a computer so as to cause the computer to achieve the function processes of the present invention achieve the present invention. Namely, the present invention also includes the computer programs themselves for achieving the function processes of the present invention.

In this case, any kind of program such as an object code, a program to be executed by an interpreter, script data to be supplied to an OS (operating system) or the like can be used as the program code if it has a program function.

As a storage medium for supplying programs, for example, a hard disk, a magnetic recording medium such as a magnetic tape or the like, an optical/magneto-optical registering medium, a non-volatile semiconductor memory, or the like may be used.

As a method of supplying a program, it is conceivable to use a method of registering the computer program for achieving the present invention to a server on a computer network, and causing a client computer connected to the server to download and execute the computer program.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-159535, filed Aug. 12, 2015, which is hereby incorporated by reference herein in its entirety.

What is claimed is:

1. A content managing apparatus comprising:
a processor; and
a memory storing a program which, when executed by the processor, causes the content managing apparatus to:
retrieve a content, by using a retrieval condition based on a first piece of attribute information associated with the content;
display the retrieval condition and the retrieved content on a screen;
acquire a second piece of the attribute information different from the first piece of the attribute information used for the retrieval condition, associated with the content selected by a user from the displayed contents; and
generate a new retrieval condition by adding the second piece of the attribute information to the retrieval condition.

2. The content managing apparatus according to claim 1, the program further causes the content managing apparatus to sort the retrieval condition or the new retrieval condition.

3. The content managing apparatus according to claim 1, the program further causes the content managing apparatus to store the retrieval condition and the new retrieval condition in a storing unit,
wherein, in a case where another retrieval condition by which the content same as the content acquired by the retrieval using the new retrieval condition exists in the storing unit, the program causes the content managing apparatus to display the another retrieval condition together with the new retrieval condition.

4. The content managing apparatus according to claim 3, wherein the program causes the content managing apparatus to retrieve the content by using the retrieval condition selected from the retrieval conditions stored in the storing unit.

5. The content managing apparatus according to claim 3, the program further causes the content managing apparatus to delete the retrieval condition selected from the retrieval conditions stored in the storing unit.

6. The content managing apparatus according to claim 3, the program further causes the content managing apparatus to edit the retrieval condition.

7. A content managing method comprising:
retrieving a content, by using a retrieval condition based on a first piece of attribute information associated with the content;
displaying the retrieval condition and the retrieved content on a screen;
acquiring a second piece of the attribute information different from the first piece of the attribute information used for the retrieval condition, associated with the content selected by a user from the displayed contents; and
generating a new retrieval condition by adding the second piece of the attribute information to the retrieval condition.

8. A non-transitory computer-readable storage medium which stores a program for causing a computer to perform:
a step of retrieving a content, by using a retrieval condition based on a first piece of attribute information associated with the content;
a step of displaying the retrieval condition and the retrieved content on a screen;
a step of acquiring a second piece of the attribute information different from the first piece of the attribute information used for the retrieval condition, associated with the content selected by a user from the displayed contents; and
a step of generating a new retrieval condition by adding the second piece of the attribute information to the retrieval condition.
